(19) United States
(12) Patent Application Publication
(10) Pub. No.: US 2024/0280023 A1
(43) Pub. Date: Aug. 22, 2024

(54) METHOD FOR SIMULATING PARTICLE IMPACT

(71) Applicant: MTU Aero Engines AG, Munich (DE)

(72) Inventors: Julia Hoermann, Munich (DE); Joerg Frischbier, Munich (DE); Hans-Peter Hackenberg, Munich (DE); Andreas Fischersworring-Bunk, Munich (DE)

(21) Appl. No.: 18/442,139

(22) Filed: Feb. 15, 2024

(30) Foreign Application Priority Data
Feb. 17, 2023 (EP) 23157229.8

(51) Int. Cl. F01D 5/12; F01D 9/02; F01D 17/02

(52) U.S. Cl. CPC F01D 5/12; F01D 9/02; F01D 17/02; F05D 2220/323; F05D 2230/72; F05D 2240/12; F05D 2240/30; F05D 2260/81

(57) ABSTRACT

A computer-implemented method for simulating particle impacts in a gas path of an aircraft engine, the method including i) providing a structural-mechanical model of at least one section of the gas path, the model including structurally or mechanically modeled airfoils, ii) placing a particle at a position in the gas path of the model, iii) moving the particle with a velocity vector that was previously determined in a computational fluid dynamics (CFD) simulation in a CFD model of the at least one section of the gas path for a fluid flowing through the gas path, and iv) detecting an impact when the moving particle hits a component of the structural-mechanical model.

### CROSS REFERENCE TO RELATED APPLICATIONS

This application claims benefit to European Patent Application No. EP 23157229.8, filed on Feb. 17, 2023, which is hereby incorporated by reference herein.

### FIELD

The present invention relates to a computer-implemented method for simulating particle impacts.

### BACKGROUND

During operation of an aircraft engine, intake air is compressed in the compressor before it is mixed with fuel and burned in the combustor. The resulting hot gas is expanded in the downstream turbine and proportionally converted into kinetic energy to generate propulsion. In particular, both the compressor and the turbine may be multi-stage, and a respective stage may have a stator vane assembly and a rotor blade assembly, i.e., a stator vane ring and a rotor blade ring.

Over the operating time of an engine, particles carried within the gas path can cause damage. In particular, very small hard particles can be critical, for example, for high-speed turbine blades (e.g., of a low-pressure turbine module). Such objects carried within the gas path (hereinafter generically referred to as “particles”) may enter the engine from outside, i.e., may be drawn in by the compressor, for example, during take-off or landing. This is referred to as Foreign Object Damage (FOD). Furthermore, the particles may also originate from the engine itself, for example, as fragments detaching from protective layers which degrade over the service life, or the like, which is referred to as Bill Of Material Damage (BOMD) or Domestic Object Damage (DOD).

Regardless of the type or the particle that may be the cause of potential damage, inspections of engines that have been in service can only be performed at great expense during an overhaul. This makes analysis difficult in general, and, in particular, it is hardly possible to examine systematic relationships on the basis of statistical considerations.

### SUMMARY

In an embodiment, the present disclosure provides a computer-implemented method for simulating particle impacts in a gas path of an aircraft engine, the method comprising i) providing a structural-mechanical model of at least one section of the gas path, the model including structurally or mechanically modeled airfoils, ii) placing a particle at a position in the gas path of the model, iii) moving the particle with a velocity vector that was previously determined in a computational fluid dynamics (CFD) simulation in a CFD model of the at least one section of the gas path for a fluid flowing through the gas path, and iv) detecting an impact when the moving particle hits a component of the structural-mechanical model.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a schematic axial cross-sectional view of an aircraft engine;

FIG. 2a and FIG. 2b illustrate schematic representations of two models for modeling components in a gas path of an aircraft engine;

FIG. 3 illustrates a flow chart illustrating several steps in the simulation of particle impacts;

FIG. 4 illustrates a schematic view illustrating the quasi-plastic modeling of an impact; and

FIG. 5 illustrates a schematic view of an airfoil that was simulated in a method according to FIG. 3 and, as a consequence, was mechanically reinforced in a region thereof.

### DETAILED DESCRIPTION

In an embodiment, the present invention provides a computer-implemented method for simulating particle impacts. The method can be implemented to simulate particle impacts in a gas path of an aircraft engine. This method is based on a combination of a Computational Fluid Dynamics (CFD) simulation of a fluid flowing through the gas path and a structural-mechanical simulation of airfoils (of a stator vane assembly and/or a rotor blade assembly) disposed in the gas path. In particular, a structural-mechanical model of at least one section of the gas path having a plurality of airfoils therein is created, and a particle is placed herein (ii). The particle is then moved (iii) through the modeled gas path, and it is determined whether the particle hits one of the airfoils, i.e., whether an impact occurs (iv). In step iii), a velocity vector is defined for the particle, which velocity vector was previously determined in the CFD simulation for the fluid flowing through the gas path.

In this way, firstly, a correlation is created between the fluid flow and the movement of the particle, whose movement and possible impact can be examined in the structural-mechanical model. Secondly, the computational effort can thus be kept manageable, which can allow for a larger number of examinations/simulations and, thus, statistical considerations. The particle can, for example, be placed at different points of the structural-mechanical model (in particular with respect to the circumferential and radial directions, but also axially) and be tracked through the model, which makes it possible to determine, for example, airfoils or regions thereof (or other parts in the gas path) that are particularly prone to impacts (impingements). These can then be optimized accordingly, for example, already during manufacture (e.g., protective coatings, structural-mechanical reinforcement, or stress relief) or also be considered, for example, in determining overhaul intervals and replacement cycles.

In the description of the features, a distinction is not always specifically made between embodiment categories. For example, when a method for simulating a component is described, such description should always also be understood as disclosing a method for designing a component in which method the component is simulated accordingly, and as a corresponding method of manufacture, etc. The CFD simulation can be performed in the sense of a method step prior to the structural-mechanical simulation. However, the results of the CFD simulation can already be present and read-in in the course of the present method (in step iii).

As will be discussed in detail below, the simulation of particle impacts can, in particular, also be used in designing a component which is then used in the gas path of the engine or bounds the gas path. This can in general also be a so-called “gas path panel,” which bounds the gas path radially inwardly or outwardly, but in particular can also be a blade or vane or the airfoil thereof.

Preferably, the structural-mechanical model maps the gas path or the considered section thereof, including a radially inward and/or a radially outward boundary; i.e., the particle can hit not only one of the airfoils, but also a radially inner and/or a radially outer gas path wall (which is formed, e.g., by a gas path panel). However, neither the CFD model nor the structural-mechanical model has to cover the entire gas path (in any case, a “section” thereof is modeled).

The terms “axial,” “radial,” and “circumferential” as well as the corresponding directions (axial direction, etc.) are generally taken with respect to the longitudinal axis of the engine, about which its rotor blade assemblies rotate during operation, for example. In the CFD model or also in the structural-mechanical model, the longitudinal axis can, for example, be an axis for a rotational symmetry of the model. In step ii), the particle is placed at a point (“starting point”) in the gas path of the structural-mechanical model, i.e., between its rotor blades, for example, axially between two successive airfoil assemblies; but in general also within an airfoil assembly (at a circumferential position between the airfoils).

The CFD model extends over at least that section of the gas path in which the starting point is located, preferably over all blade and vane assemblies of the structural-mechanical model. In principle, a flow field is obtained from the CFD simulation, i.e., a velocity vector at each particular point. A “velocity vector” includes the velocity (magnitude) and its direction (unit vector). This vector field can be present with a granularity corresponding to the resolution (mesh) of the CFD model. In step iii), the velocity vector can then, for example, be taken at that point of the vector field (i.e., that element of the meshed CFD model) which corresponds to the starting point in terms of its spatial coordinates; alternatively, a mean value can be formed, for example (see below).

In the structural-mechanical model, in addition to the starting point and the velocity, a mass and/or a volume, for example, in particular also a shape, can be defined for the particle. With regard to the computational effort, a simply modeled particle can be preferred, such as one having a spherical shape.

In general, the structural-mechanical model extends axially, for example, over at least one first airfoil assembly, i.e., a rotor blade assembly or a stator vane assembly, preferably over a plurality or multiplicity of successive airfoil assemblies. According to a preferred embodiment, a first velocity vector with which the particle is moved into the first airfoil assembly is formed as a mean value of a velocity vector determined at the inlet edge of the first airfoil assembly in the CFD simulation and a velocity vector determined at the exit edge thereof in the CFD simulation. The “inlet edge” is considered to be the plane that results from a rotation of a leading edge of an airfoil of the first rotor blade assembly about the longitudinal axis; the “exit edge” is formed analogously by a corresponding rotation of the trailing edge of the airfoil.

In a simple case, the velocity vectors used for averaging can, for example, be taken at the same circumferential and radial positions, but alternatively, points (elements) on the same streamline can also be used as a basis. The averaging itself can concern the magnitude of the velocity and/or the direction, preferably both. Regardless of these details, the averaging can be advantageous in that it represents a certain deflection of the flow within the airfoil assembly without significantly increasing the computational effort (see the remarks made at the outset).

The first particle is moved with a first velocity vector into the first airfoil assembly, regardless of whether this velocity vector is determined by averaging or taken as a discrete value on the inlet side of the first airfoil assembly. On the exit side of the first airfoil assembly, the particle then moves with a first resulting velocity vector. The first resulting velocity vector can, for example, be equal to the first velocity vector if no impact occurs within the first airfoil assembly, i.e., if the particle simply passes therethrough. However, if an impact occurs and this is taken into account by at least a change in the direction of the particle, then the first resulting velocity vector can have a different direction (and possibly also a different magnitude, see below for more details).

In a preferred embodiment, the movement of the particle between the first and the second airfoil assembly is corrected, regardless of the details of how the first resulting velocity vector is obtained. This is done on the inlet side of the second airfoil assembly with a second velocity vector, which is taken from the CFD simulation. In general, “on the inlet side” means at the inlet edge of the respective airfoil assembly or upstream thereof (maximally to the rearward edge of the upstream airfoil assembly); similarly, “on the exit side” means at the rearward edge of the respective airfoil assembly or downstream thereof (maximally to the inlet edge of the downstream airfoil assembly).

According to a preferred embodiment, the structural-mechanical model extends over multiple successive airfoil assemblies, for example, at least 3, 4, or 5 airfoil assemblies; e.g., rotor blade and stator vane assemblies arranged in alternating succession (with possible upper limits being 30, 20, or 15, for example). Downstream of each airfoil assembly, there is a respective resulting velocity vector, i.e., the first resulting velocity vector downstream of the first airfoil assembly (see above), a second resulting velocity vector downstream of the second airfoil assembly, and so on. In a preferred embodiment, a resulting velocity vector between two respective airfoil assemblies is corrected there with a velocity vector taken from the CFD simulation, for example, on the inlet side of the downstream airfoil assembly. Thus, in the case of n airfoil assemblies, there can be, for example, at least or exactly (n−1) corresponding corrections, at least or exactly one correction between each two airfoil assemblies.

According to a preferred embodiment, when an impact of the particle occurs, it is moved further with a changed velocity vector. This is, in any case, the direction vector of the movement is changed, and the magnitude of the velocity can, in general, remain unchanged. In a simple case, the resulting vector can be determined according to the law of reflection (the incident and outgoing trajectories of movement are in the same plane as the normal at the point of incidence, and: angle of incidence=angle of reflection).

Alternatively or in addition to the changed velocity vector, the particle can also be moved further with a changed shape after the impact; i.e., a changed shape can be defined for it. This can mean a changed geometric shape, such as an oblate ellipsoid of revolution instead of a sphere or a prolate rotational ellipsoid, and/or a changed volume. The particle that is moved further after the impact can, for example, have a smaller volume than before the impact. After the impact, the particle can still be modeled as a coherent body, but it can also be split into a plurality of sub-particles at impact, which also results in a “changed shape.” The sub-particles can, for example, be moved through the structural-mechanical model independently of each other as “particles” in a manner disclosed herein.

In a preferred embodiment, the impact is modeled quasi-plastically, namely, the velocity magnitude of the velocity vector is reduced at impact (in addition to the change in direction). A factor by which the velocity magnitude is reduced can preferably be determined separately in a structural-mechanical simulation which models the impact plastically. Preferably, the velocity magnitude is reduced at impact by a factor that is velocity- and/or angle-dependent. In general, the quasi-plastic modeling can yield a good approximation without significantly increasing the computational effort.

In general, and regardless of the shape or velocity with which the particle is moved further after the impact, it continues to be tracked or observed after the impact. In this connection, there can be several impacts along the path of motion of the particle, for example, in the axially successive airfoil assemblies and/or also therebetween. Furthermore, there can also be several velocity corrections along the path of motion, for example, independently of an impact by calibration with the CFD simulation (see above) and/or in the event of an impact (see the preceding paragraphs). In general, the path of motion can then preferably extend over the entire structural-mechanical model.

In principle, the impact location(s) can already be used for designing and/or producing an optimized airfoil, in particular in the case of multiple simulations and thus multiple paths of motion (see below); namely, impact-prone regions can be especially protected or reinforced (see below). According to a preferred embodiment, when an impact occurs, its effect on the component, in particular the component damage, is further modeled and assessed.

In this connection, one or more component and/or particle parameters can be taken into account, in particular the impact angle (e.g., steeper→higher degree of damage), the impact velocity (e.g., higher→greater degree of damage), the impact energy (e.g., higher→greater degree of damage), the component thickness (e.g., lower→greater degree of damage), the component stress (e.g., higher→greater degree of damage), the component material (e.g., brittle or ductile), the particle material or its properties (e.g., higher strength→greater degree of damage) and/or the particle size (larger→higher degree of damage). In this way, any preventive measures can then, for example, be used even more specifically in design and manufacture, for example, when particularly fast and therefore critical particles hit a particular region, e.g., with a specific radial distribution.

According to a preferred embodiment, multiple particles are moved through the structural-mechanical model; i.e., steps ii) through iv) are performed for a multiplicity of particles. “Multiple/a multiplicity of” can mean, for example, at least 10, 25, 50, 100, 200, 500, or 1000 (with exemplary upper limits being 1E8, 1E7, or 1E6). Moreover, regardless of a particular number, the particles can be placed, for example, on the inlet side of the same airfoil assembly (e.g., of the first airfoil assembly), but the radial and/or circumferential positions can be varied. Alternatively or additionally, the particles can also be placed at different axial positions; for example, to study BOMD/DOD events.

Using the disclosed approach, the computational effort can also be kept manageable when multiple simulations are carried out; i.e., dependencies and distributions can be investigated. Accordingly, it is possible to determine frequencies and distributions of impacts for the individual components in the gas path, i.e., to perform Monte Carlo simulations, for example. In addition, for example, an impact severity can be determined from the velocity magnitude at impact; i.e., it is not only clear for the individual components where how many particles on average impinge, but also how violent these impacts are. This reflects the amount of energy input, which can be decisive for the damaging effect. This allows a corresponding component, in particular an airfoil, to be specifically adapted, e.g., structurally/mechanically reinforced and/or stress-mechanically relieved, in the design process.

According to a preferred embodiment, the simulation is calibrated with a component or engine that has been in service; i.e., a (first) aircraft engine of which a used component or module is available is modeled. The component or module is then examined for damage, in particular particle impacts; in other words, a map of impacts on a real component is created. The simulation, especially of multiple particles, is then adapted to this map. Using the simulations, it is possible, in particular, to vary component parameters, such as number, position and/or distribution, with the proviso that the simulated effects will then substantially match the component or module that has been in service. The latter can, for example, be to the effect that the spatial distribution of the impacts is approximated to the mapped distribution, it being possible, for example, to additionally take into account a modeled impact effect, in particular the severity of damage.

The particle parameters determined by this calibration can then preferably be used to model a second aircraft engine, i.e., to predict component damage on a second aircraft engine, which can, in particular, still be in a design or test phase. The second aircraft engine can differ from the first aircraft engine in terms of its operating conditions and/or geometries, i.e., can be a further development thereof. Using the particle parameters calibrated in the first step on the basis of the components that have been in service, the second aircraft engine can then be examined, for example in an early design phase, as to whether or where there are damage-prone regions for which special precautions can then be taken in a manner described below. The second aircraft engine is modeled using the particle parameters determined from the first aircraft engine; these parameters are, as it were, transferred to the geometry and operating conditions of the second aircraft engine. The latter means that, for example, a particle distribution determined on the basis of the first aircraft engine is moved through the structural-mechanical model of the second aircraft engine with the operating conditions of the second aircraft engine, i.e., the velocities determined from the CFD simulation performed for it, the structural-mechanical model representing the new geometry.

In a preferred embodiment, damage in the used component can be evaluated so as to determine the energy associated with a particular damage. For example, the impact energy that the particle must have had can be determined based on the size of the crater, e.g., its circumference and/or depth. Furthermore, an associated size and/or mass of the item can then be determined for this energy. These variables can then be taken in account as particle parameters in the simulation of a new engine, i.e., can be defined for the particle(s) there.

An embodiment of the invention also relates to a method for designing a component for an aircraft engine, wherein the component is modeled as part of a structural-mechanical model according to step i) and examined according to steps ii) to iv) as to whether/to what extent it is prone to impacts. Some airfoil assemblies and their airfoils can, for example, be generally more prone to impact due to their axial position; but there can, for example, also be a distribution within a respective airfoil assembly, such as radially unevenly distributed impact frequencies/severities.

In the course of the design process, if at least one region of the component, in particular of the airfoil, is identified as prone to impact, a countermeasure can be taken at least in this region or for the component as a whole. In this connection, “countermeasure” means a design feature of the component/airfoil that reduces the effects of a particle impact when it does happen. This can be a structural-mechanical reinforcement, for example a selective thickening (e.g., at the leading edge), i.e., more material, in at least the region of the airfoil. Alternatively or additionally, it is also possible to optimize the microstructure, for example by adapting the production processes or the material composition.

Alternatively or additionally, an airfoil can, for example, also be designed in such a way that its intrinsic mechanical stress level is reduced during operation. In the case of a rotor blade airfoil, this can be achieved, for example, by centrifugal and gas forces at least partially canceling each other out. For this purpose, the blade can, for example, be provided with a lean, i.e., a tilt. Due to the reduced level of mechanical stress, the component or airfoil is then less vulnerable in the event of a particle impact; i.e., the degree of damage introduced by the particle impact can be reduced. Another design feature can be a protective coating, which can be applied locally in a region identified as critical or also to the entire surface of the component as a countermeasure. It is also possible, for example, to optimize the microstructure of the component at least in one or more regions in such a way that higher fracture toughness is achieved.

In general, a countermeasure can then have been taken for the designed or manufactured component, in particular in a region thereof; i.e., the component can, for example, be characterized in that a region thereof differs from the surrounding area in accordance with the countermeasure taken. I.e., for example, a portion of the component surface facing the gas path can be affected by the measure, while another portion can not be affected.

An embodiment of the invention also relates to a method for producing a component intended for an aircraft engine, in particular an airfoil, wherein the component is or was designed in a design process as described above. During manufacture, a component shape determined in this design process can then be produced, for example, by material-removing machining (machining from a solid material) and/or by a material-deposition process; i.e., the component can, for example, be additively manufactured or coated.

An embodiment of the invention also relates to a correspondingly designed and/or manufactured component, in particular a blade or vane or an airfoil.

Furthermore, an embodiment of the invention relates to a method for overhauling a component that has been used in the gas path of an aircraft engine that has been in service. In the course of the overhaul, the component, in particular its surface facing the gas path, can be inspected and can then additionally be reworked and/or replaced, for example. In this connection, an operating time (e.g., the operating hours) after which this overhaul is carried out is or was determined based on a method with which a multiplicity of particles are or were simulated as described above. An appropriate time for the overhaul can be determined from the resulting impact frequency and severity distributions. Accordingly, the operating time will be shorter when the impact density/severity levels are higher and comparatively longer when the impact density/severity levels are lower. The operating times after which overhauls are performed can, for example, differ even for aircraft engines of identical design, depending, for example, on different operating conditions.

The data obtained from modeling can, for example, also be used or have been used to determine a maximum allowable operating time after which, for example, a component in service is then overhauled and/or replaced.

An embodiment of the invention further relates to a computer program product including commands which, when executed on a computing unit, cause the computing unit to perform a simulation method as described at the outset. An embodiment of the invention also relates to a computer-readable medium on which such a computer program product is stored.

Embodiments of the invention will now be described in more detail with reference to an exemplary embodiment. Individual features of an embodiment can also be essential to other embodiments of the invention in other combinations within the scope of the present disclosure, and, as above, no distinction is specifically made between embodiment categories.

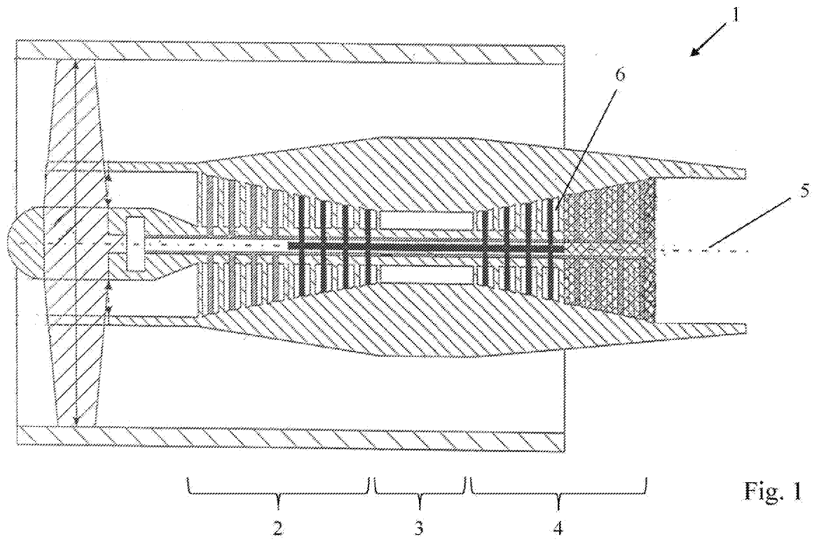

FIG. 1 shows an aircraft engine 1, here a turbofan engine. The aircraft engine is functionally divided into a compressor 2, a combustor 3, and a turbine 4. During operation, intake air is compressed in compressor 2, mixed and burned with fuel in the downstream combustor 3, and the hot gas is then expanded in turbine 4. Compressor 2 and turbine 4 are both multi-stage in design, a respective stage including a stator vane assembly and a rotor blade assembly. The latter rotate about longitudinal axis 5 during operation.

As detailed in the introductory part of the description, particles can enter the gas path 6 of the aircraft engine during operation thereof, the gas path being exemplarily referenced here in the area of turbine 4. These particles can be of external origin (FOD) or of internal origin (BOMD/DOD). In any case, as a result, they move in gas path 6 at relatively high velocities, which poses a risk of damage in the event of impacts.

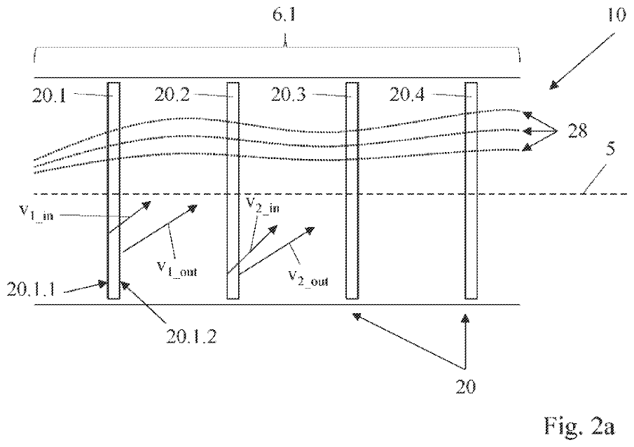

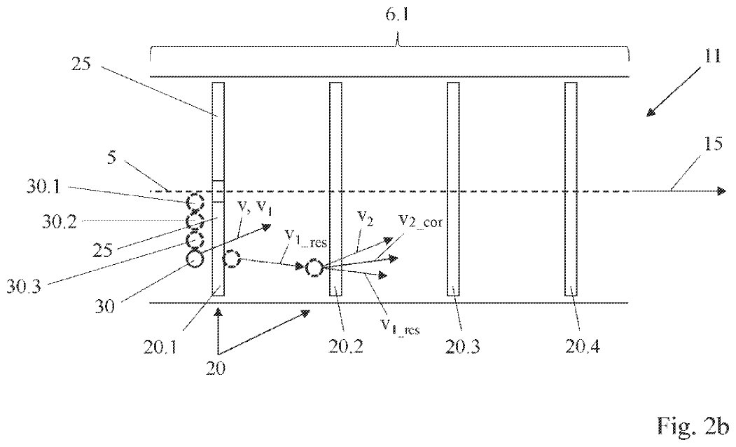

FIGS. 2a, b each schematically illustrate a section 6.1 of gas path 6, which in FIG. 2a is modeled in a CFD model 10. FIG. 2b in turn shows a structural-mechanical model of section 6.1 of gas path 6. This model extends in axial direction 15 over several airfoil assemblies 20, in the present example over a first airfoil assembly 20.1, a second airfoil assembly 20.2, a third airfoil assembly 20.3, and a fourth airfoil assembly 20.4. Airfoils 25 are schematically drawn for the first airfoil assembly 20.1. Due to the utilization of symmetries about longitudinal axis 5, models 10, 11 do not, of course, actually have to extend completely thereabout, respectively (unlike shown here in the schematic diagrams).

In CFD model 10, a generally known CFD simulation is performed for airfoil assemblies 20. In structural mechanical model 11, a particle 30 is placed, which is then moved with a velocity vector v through model 11, i.e., through section 6.1 of gas path 6. This velocity vector v is taken from the CFD simulation; i.e., it is based on the velocity field determined for the flowing fluid.

In more detail, particle 30 is moved with a first velocity vector v₁ into the first airfoil assembly 20.1, the first vector v₁ preferably being obtained by averaging from the CFD simulation. This averaging concerns a velocity vector v_{1_in} at the inlet edge 20.1.1 of the first airfoil assembly 20.1 and a velocity vector v_{1_out} at the corresponding location at the exit edge 20.1.2 and yields a first velocity vector v₁. In structural-mechanical model 11, this first velocity vector v₁ is defined for particle 30 on the inlet side of the first airfoil assembly 20.1.

Downstream of the first airfoil assembly 20.1, particle 30 (shown in broken line) has a first resulting velocity vector v_{1_res}, which here differs from the first velocity vector v₁ as a result of an impact. Before particle 30 is moved into the second airfoil assembly 20.2, the first resulting velocity vector v_{1_res} is corrected, namely with a second velocity vector v₂, which in turn is obtained from CFD model 10, namely by averaging v_{2_in} and v_{2_out}. In more detail, these velocities can be at the inlet and exit edges, for example on a common streamline 28 (shown here at a different point in model 10 for the sake of clarity). In this way, particle 30 can be successively moved through airfoil assemblies 20 of model 11, the motion vector resulting from impacts and/or (repeated) correction based on CFD model 10.

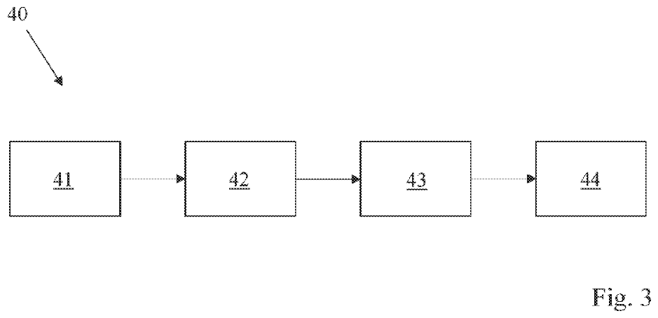

FIG. 3 summarizes some of the method steps in a flow chart 40. After providing 41 the structural-mechanical model 11, a particle 30 is placed therein, which is then moved 43 through model 11. A possible impact is detected 44, for example, when particle 30 hits an airfoil 25. Steps 42-44 can be repeated many times, whereby, by placing the particles 30.1-30.3 at different points (see FIG. 2b), statements can be made about distributions (for more details, see the introductory part of the description).

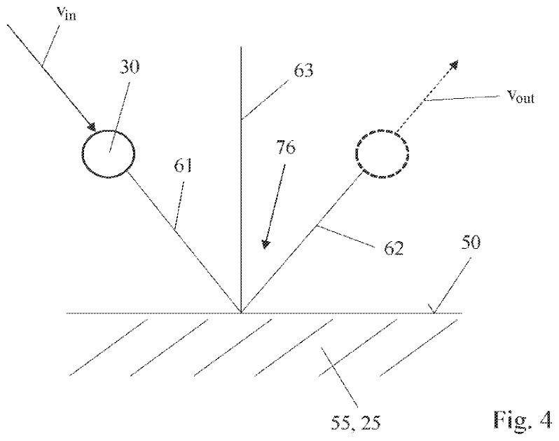

FIG. 4 schematically illustrates the impingement of particle 30 on a surface 50 of a component 55, e.g., of an airfoil 25. Particle 30 is incident on surface 50 with a velocity vector vᵢₙ, whereupon it moves further with a velocity vector vₒᵤₜ. There can be seen an incident and an outgoing trajectory of movement 61, 62 of particle 30, as well as a normal 63. The impact 76 is modeled quasi-plastically; the direction vector vₒᵤₜ is less than vᵢₙ in terms of magnitude. A corresponding factor by which the magnitude is reduced can be determined in a separate structural-mechanical simulation.

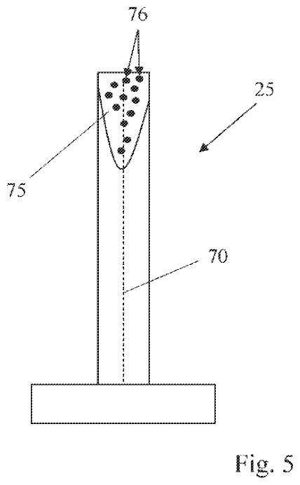

FIG. 5 shows an airfoil 25 in a schematic view looking at its leading edge 70. Simulations were performed with multiple particles 30.1-30.3 in a manner described above, whereby a region 75 with a high number of impacts 76 was identified. This region 75 is particularly prone to particle impacts, and airfoil 25 is provided there with a protective coating.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

Aircraft engine 1
Compressor 2
Combustor 3
Turbine 4
Longitudinal axis 5
Gas path 6
Section 6.1
Models 10, 11
Axial direction 15
Several airfoil assemblies 20
   first airfoil assembly 20.1
      inlet edge 20.1.1
   second airfoil assembly 20.2
      exit edge 20.1.2
   third airfoil assembly 20.3
   fourth airfoil assembly 20.4
Airfoils 25
Streamline 28
Particles 30, 30.1-30.3
Flow chart 40
Providing 41
Method step 42-44
Surface 50
Component 55
Trajectory of movement 61, 62
Normal 63
Leading edge 70
Region 75
Impact 76

1. A computer-implemented method for simulating particle impacts in a gas path of an aircraft engine, the method comprising:
i) providing a structural-mechanical model of at least one section of the gas path, the model including structurally or mechanically modeled airfoils;
ii) placing a particle at a position in the gas path of the model;
iii) moving the particle with a velocity vector that was previously determined in a computational fluid dynamics (CFD) simulation in a CFD model of the at least one section of the gas path for a fluid flowing through the gas path; and
iv) detecting an impact when the moving particle hits a component of the structural-mechanical model.

2. The method as recited in claim 1, wherein the structural-mechanical model extends axially over at least a first airfoil assembly and a second airfoil assembly downstream thereof, and
wherein, in step iii), the particle is moved with a first velocity vector through the first airfoil assembly, and a first resulting velocity vector, which the particle has on an inlet side of the second airfoil assembly, is corrected there with a second velocity vector from the CFD simulation.

3. The method as recited in claim 1, wherein, after the impact is detected according to step iv), the particle is moved further with a changed velocity vector and/or with a changed shape.

4. The method as recited in claim 3, wherein the impact is modeled quasi-plastically, and a velocity of the particle taken as a magnitude is reduced at the impact.

5. The method as recited in claim 1, wherein, when the impact is detected according to step iv), an effect on the component as a result of the impact is determined, taking into account at least one of the following parameters: impact angle, impact velocity, impact energy, component thickness, component stress, component material, particle material, particle properties, particle size, and particle mass.

6. The method as recited in claim 5, wherein multiple particles are moved through the structural-mechanical model according to steps ii) through iv), and multiple impacts are detected, and
wherein in step ii), each of the particles are placed at different points in the gas path.

7. The method as recited in claim 6, further comprising:
predicting component damage caused by impact of particles by:
reproducing a damage pattern of a used component from a first aircraft engine by varying particle parameters until the determined effect substantially corresponds to damage pattern of the used component,
wherein the particle parameters include a number, position, and/or distribution; and
predicting component damage in a second aircraft engine based on particle parameters, operating conditions, and geometries of the second aircraft engine,
wherein the operating conditions and geometries of the second aircraft engine differ from those of the first aircraft engine.

8. The method as recited in claim 7, wherein a size and/or a mass of a particle is determined by evaluating damage to the used component by first determining an energy associated with the damage and determining an associated size and/or mass of the particle for this energy.

9. A method for designing a component for a gas path of an aircraft engine or a component assembly including the component, comprising:
modeling the component as part of a structural-mechanical model of at least one section of the gas path; and
using the model to simulate damage caused by a particle impact by:
placing the particle at a position in the gas path of the structural-mechanical model;
moving the particle with a velocity vector that was previously determined in a computational fluid dynamics (CFD) simulation in a CFD model of the at least one section of the gas path for a fluid flowing through the gas path;
detecting an impact when the moving particle hits a component of the structural-mechanical model; and
determining damage on the component of the structural-mechanical model as a result of the impact.

10. The method as recited in claim 9, further comprising:
identifying a region of the component in which impact-induced damage is detected as a vulnerable spot; and
implementing a countermeasure in the region of the vulnerable spot, the countermeasure including at least one of the following: a structural-mechanical reinforcement, a stress-mechanical relief, an optimization of the microstructure, and a coating.

11. A method for producing an airfoil for an aircraft engine, the method comprising:
designing the airfoil according to the method of claim 10, wherein the countermeasure is implemented such that the vulnerable spot differs from surrounding areas of the airfoil in accordance with the countermeasure taken; and
producing the airfoil according to the designed airfoil.

12. A method for performing maintenance on an aircraft engine, comprising:
carrying out the method according to claim 7;
deriving a predicted operating time of the component of the structural-mechanical model based on the predicted component damage; and
overhauling, replacing, or removing a blade or vane for the aircraft engine that has been used in a gas path of the aircraft engine during operation thereof based on the predicted operating time.

13. The method according to claim 7, further comprising deriving a maximum operating time of the component of the structural-mechanical model based on the predicted component damage.

14. A non-transitory computer-readable medium having processor-executable instructions stored thereon, wherein the processor-executable instructions, when executed by one or more processors, facilitate performance of the method of claim 1.

15. A blade or vane designed according to the method of claim 9.

16. A blade or vane produced according to the method of claim 11.

17. The method as recited in claim 5, wherein the effect on the component includes damage to the component.
